(19) United States
(12) Patent Application Publication
(10) Pub. No.: US 2012/0130739 A1
(43) Pub. Date: May 24, 2012

(54) Unsupervised Telemedical Office for Remote &/or Autonomous & Automated Medical Care of Patients

(76) Inventor: David Crane, Montrose, CO (US)

(21) Appl. No.: 12/951,045

(22) Filed: Nov. 21, 2010

(51) Int. Cl. G06Q 50/00; G06Q 10/00

(52) U.S. Cl. 705/3; 705/2; 901/50

(57) ABSTRACT

Methods and systems creating Telemedical offices to remotely &/or automatically perform patient identification & intake, vitals measuring & recording, symptom reporting, live & delayed consultation by medical professionals, various and unlimited outpatient medical testing, live &/or automated diagnostic, referral, prescribing, treatment, billing, payment processing and record keeping services remotely by live & time-shifted medical professionals, medical and non-medical sensors, robotics (the robotics are not patented, but are used as a tool in the invention to help deliver the the services), autonomous systems and automated systems. The positive identification and teleconferencing capabilities also enable uses beyond the scope of medicine that also require positive identification prior to or during videoconferencing. The invention results in improved quality in medical service delivery, broad distribution of medical services and efficiencies in financial and time resources.

### CROSS REFERENCE TO RELATED APPLICATIONS

| Patent # | Date | Inventor | Relationship to Current Application |
|---|---|---|---|
| 7,761,463 | Jul. 20, | Wheeler | Allows patient self-check in, |
| | 2010 | | but relies on keycards/passwords/ |
| | | | etc. Our invention differs |
| | | | substantially by using biometrics |
| | | | and adds functions of medical office. |
| 6,594,607 | Jul. 15, | Lavery | Allows for remote test of diabetes |
| | 2003 | | induced eye problems. Our invention |
| | | | differs substantially by allowing for |
| | | | the remote testing of countless |
| | | | medical conditions. |
| 5,951,469 | Sep. 14, | Yamaura | Is a system to find a counseling |
| | 1999 | | doctor via telephone for voice |
| | | | communication. Our invention differs |
| | | | substantially by allowing for |
| | | | communication over any data line, |
| | | | includes videoconferencing, |
| | | | is a facility that enables most |
| | | | functions of a medical office to |
| | | | be performed not only remotely, |
| | | | but also has many autonomous |
| | | | systems built in. |
| 7,761,185 | Jul. 20, | Wang | Allows teleconferencing with a |
| | 2010 | | remote physician. Our invention |
| | | | differs substantially because |
| | | | while theirs requires the assistance |
| | | | of other medical professionals at |
| | | | the patient's location because |
| | | | no additional medical sensors are a |
| | | | part of this system. Also, their system |
| | | | is intended to be mobile within a |
| | | | medical facility, while ours differs |
| | | | substantially by being intended to be |
| | | | utilized also within non-medical |
| | | | facilities. |
| 6,849,045 | Feb. 1, | Iliff | Allows for computerized diagnosis of |
| | 2005 | | a patient's needs and gives |
| | | | advice, which we incorporate as a |
| | | | part of our invention, however, their |
| | | | invention differs substantially by |
| | | | failing to actually prescribe treatment |
| | | | and lacks the assistance of remote |
| | | | doctors and integrated sensors. |
| 7,306,560 | Dec. 11, | Iliff | See prior reference. Allows for |
| | 2007 | | computerized diagnosis of a patient's |
| | | | needs and gives advice, which we |
| | | | incorporate as a part of our invention, |
| | | | however, their invention differs |
| | | | substantially by failing to actually |
| | | | prescribe treatment and lacks the |
| | | | assistance of remote doctors and |
| | | | integrated sensors. |
| 7,412,396 | Aug. 12, | Haq | Enables patients to be put in touch |
| | 2008 | | with medical professionals, which |
| | | | we will also do, but their approach |
| | | | differs substantially from our |
| | | | invention because it is limited to |
| | | | traditional communications and lacks |
| | | | the use of sensors and medical |
| | | | equipment to assist in diagnosis. |
| 5,619,991 | Apr. 15, | Sloane | Allows for the communication and |
| | 1997 | | digital tracking of medical records |
| | | | for large groups and focuses on |
| | | | epidemiological data gathering |
| | | | and dissemination. While we |
| | | | communicate medical data, our |
| | | | invention differs substantially |
| | | | because our focus is more on the |
| | | | individual needs and on having |
| | | | integrated sensors and equipment |
| | | | in our invention that enables the |
| | | | collection of data necessary for |
| | | | proper diagnosis and the |
| | | | communication thereof. |

### BACKGROUND OF THE INVENTION

1. Field of the Invention

The field of this invention relates to Medical and Laboratory Equipment (Class D24), Equipment for Diagnosis, Analysis or Treatment (Sub-Class 107), Patient Service Unit or Console (Sub-Class 185) to remotely &/or automatically provide medical services to a patient at an unstaffed location. These include the standard activities one would encounter in a doctor's office or in other medical facilities.

2. Discussion of the Related Field & Invention

Telemedicine currently enables doctors to give patient care remotely, however, in every instance in use today, the patient location requires a skilled person to assist with functions that the remote doctor cannot perform due to his/her remote location (such as taking all the necessary vital signs or performing various tests the doctor would typically preform in a traditional medical office, or, in the cases when personnel at the patients location are not needed, the doctor is frequently not provided with sufficient data to make an accurate diagnosis of the patient's medical issues. Both scenarios cause problems in delivering quality medical care without the use of skilled staff at the patient's location, especially in remote, underserved and poverty-stricken areas.

In traditional medicine without the use of telemedicine, patients needing medical care call to make an appointment with their doctor, wait for the appointment and then go to the doctor's office. They then meet a receptionist at the doctor's office who identifies them and has them fill out intake sheets. The patient waits for a nurse to call them to another room to take their vitals and record their reasons for their visit. The patient then waits in another room for a doctor, who may then examine them, ask questions and order tests and/or refer them to a specialist if they are underqualified for the patient's problems (requiring the patient to go through the whole process of making another appointment, waiting, etc.) before a prescribed treatment or medication will be issued. Once the patient receives a prescription, they then have to go to yet another location and wait to get their prescription. All of this travel and waiting is a problem and a waste of the patient's time & resources.

The doctor who initially sees the patient is typically overqualified for the purpose of the majority of initial visits and these visits could have been adequately performed by a less expensive physician's assistant or a nurse practitioner. This is an inefficient method of providing medical care and often mismatches costly medical resources, creating a problem to be solved.

It also requires great resources to house, staff and equip all of the various medical professionals in so many different spaces. A more efficient method is needed.

Currently, there are effective diagnostic software solutions available that are underutilized by both patients and medical professionals because they are not sufficiently integrated with the standard or traditional administration of medical services. Further integrating them into automated systems can significantly reduce the cost of serving populations in jurisdictions where automated diagnosis is legal.

Some attempts have been made at the use of telemedicine to increase efficiencies and quality of service to the patient, but all of them fundamentally lack the ability to perform the proper tests and/or many of them require the presence of a trained staff member to assist in the administration of the medical evaluation, thus increasing the cost and inefficiency. Furthermore, many attempts use non-integrated devices for taking vital signs and require self-reporting, which may be prone to errors and falsification, thus leading to faulty evaluations and inappropriate prescriptions.

### OBJECTS AND BRIEF SUMMARY OF THE INVENTION

It is therefore the object of the invention to be able to adequately provide sensors, tests, images, data, videoconferencing and interfaces sufficient to enable a patient to receive their medical care as much as possible from automated systems and as needed, in part, from PAs, NPs, MDs, medical specialists, other medical professionals, staff, and, in locations where it is financially feasible, radiologists, phlebotomists, laboratory technicians, ultrasound technicians & various medical technicians at one point of service through remote telepresence and automated systems.

It is also the object to reduce the inefficiencies of mismatching medical professionals with the medical issue and of high overhead in physical facilities and underutilized staff and to use the power of economies of scale to decrease the cost of medicine to the patients. The system allows for the functions of a receptionist, nurse for taking vital signs and other staff to be performed by the system, thus eliminating the majority of the costs associated with these staff. The system also reduces overhead on real property expenditures because the system condenses the waiting rooms, examination rooms, vital signs areas, receptionist areas & medical record keeping areas into just one area sufficient for just the patient and some equipment, which allows for the offices/kiosks to be much smaller and less costly. Because their size is so small, the rooms can be used as portable or stationary kiosks placed in malls, grocery stores, drug stores, long-term care facilities, community senior centers, remote villages across the globe, etc.

The automated process will be the preferred means of serving the client, up to the point where the automated systems, either by limitations in technology or limitations imposed by reason or regulation, require the expertise & capabilities of a human medical professional. Some patients will be able to be served completely (depending on their needs) autonomously (i.e. Follow-up visits, vital signs monitoring, & where allowed by law, routine &/or simply diagnosed medical needs) and others will require the expertise of one or many medical professionals (i.e. Initial visits, medium to complex medical needs, routine &/or simply diagnosed medical needs in jurisdictions where autonomous diagnosis is not yet permitted, etc.), while others will only need the medical professional (i.e. Psychiatric and counseling sessions, etc.). This requires our system make use of integrated sensors, robotics, videoconferencing equipment, software, computers, medical equipment, GUIs, etc.

By integrating all of these components, doctors will have the information they need to provide accurate medical diagnosis, enormous financial and time efficiencies are gained, patients will receive as great or greater quality care, it will cost less, take less time and be more convenient and readily available and accessible for the client.

### BRIEF DESCRIPTION OF THE DRAWINGS

FIG. 1 indicates the overall systems, methods and facilities of the invention & indicates portions of the invention that can be located in different physical locations.

FIG. 1.1 Indicates the portion used directly by the medical professionals at his/her physical location. It is used to control the patient's location and acquire the information needed to perform his/her job.

FIG. 1.2 Indicates the virtual portion accessible by the medical professionals and portions thereof are accessible by the patient

FIG. 1.3 Indicates the portion at the client's physical location.

FIGS. 1.3.1-1.3.3 Indicate different systems, methods & functions at the client's location. Additional components are outlined below each section & indicate functions, equipment, systems or methods under that particular category.

### DETAILED DESCRIPTION OF THE INVENTION

The invention is a conglomeration of many systems and methods, that working together, enable autonomous and remote medical care to patients.

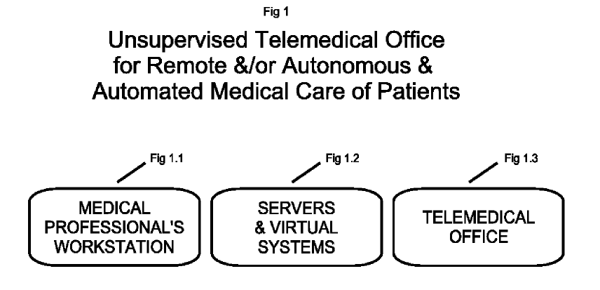

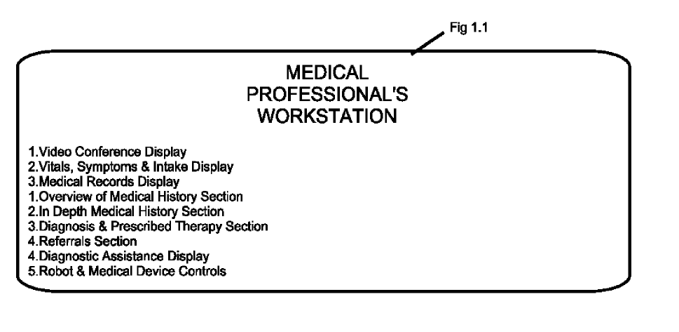

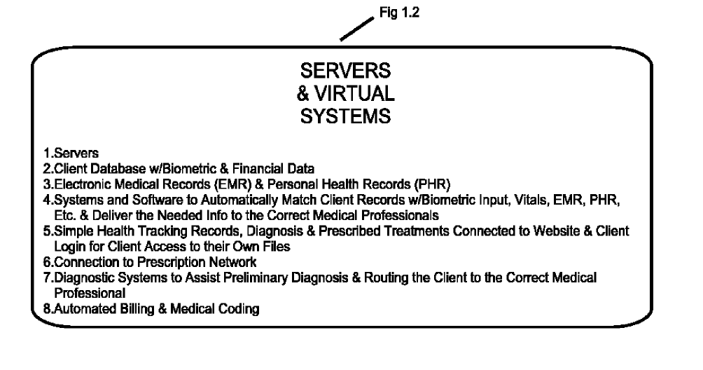

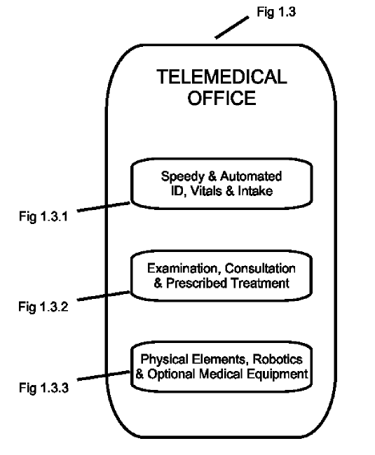

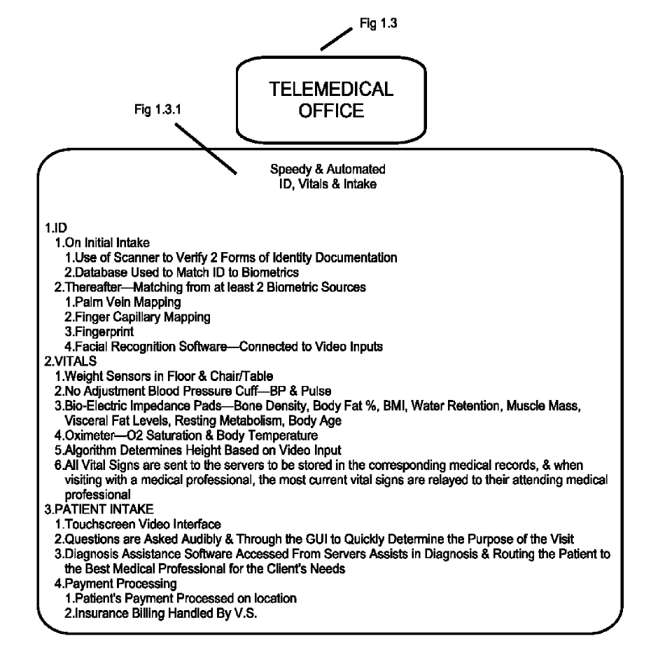

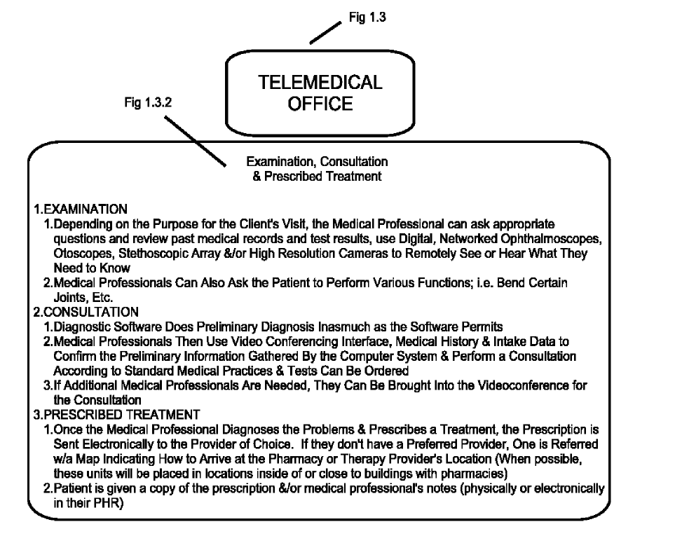

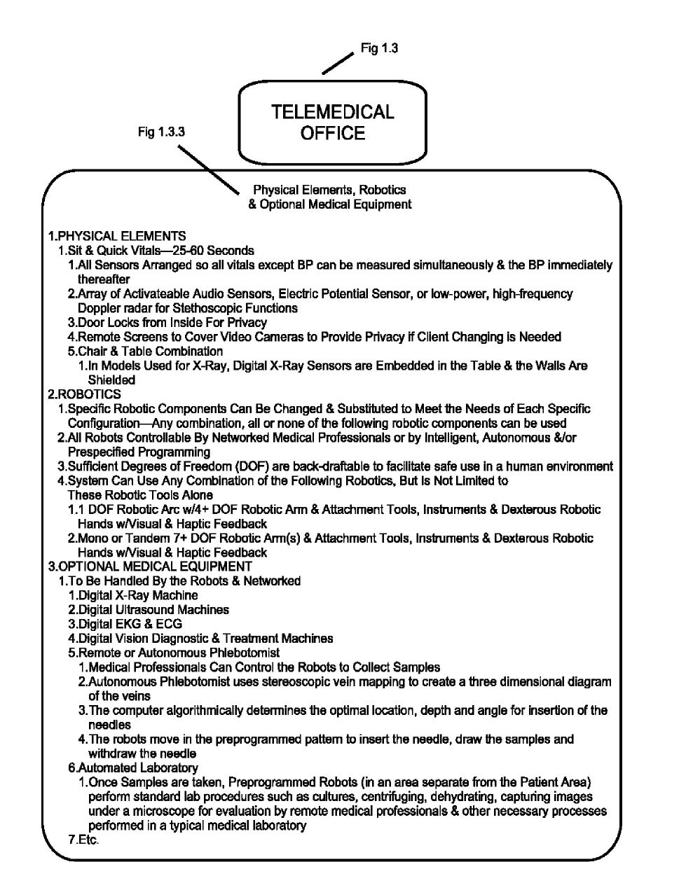

FIG. 1 Indicates the whole systems, methods and facilities of the invention. FIG. 1.1. Indicates the Medical Professional's Workstation. FIG. 1.1.1. Indicates the Video Conference Display, FIG. 1.1.2. Indicates the Vitals, Symptoms & Intake Display. FIG. 1.1.3. Indicates the Medical Records Display and FIG. 1.1.3.1. Indicates the Overview of Medical History Section, FIG. 1.1.3.2. Indicates the In Depth Medical History Section, FIG. 1.1.3.3. Indicates the Diagnosis & Prescribed Therapy Section, and FIG. 1.1.3.4. Indicates the Referrals Section. FIG. 1.1.4. Indicates the Diagnostic Assistance Display and FIG. 1.1.5. Indicates the Robots & Medical Device Controls

FIG. 1.2. Indicates the Servers & Virtual Systems. FIG. 1.2.1. Indicates the servers, FIG. 1.2.2. Indicates the Client Database containing Biometric & Financial Data, FIG. 1.2.3. Indicates the Electronic Medical Records, FIG. 1.2.4 Indicates the Systems and Software to Automatically Match Client Records w/Biometric Input, Vitals, Medical Records, Etc. & Deliver the Needed Info to the Correct Medical Professionals, FIG. 1.2.5. Indicates the Simple Health Tracking Records, Diagnosis & Prescribed Treatments Connected to Website & Client Login for Client Access to their Own Files, FIG. 1.2.6. Indicates a Connection to Prescription Network, & FIG. 1.2.7. Indicates Diagnostic Systems to Assist Preliminary Diagnosis & Routing the Client to the Correct Medical Professional. FIG. 1.2.8 Indicates that Insurance Billing and Medical Coding is done automatically by the system.

FIG. 1.3. Indicates the Telemedical Office or Patient's Location. FIG. 1.3.1. Indicates a method to have a Speedy & Automated ID, Vitals & Intake. FIG. 1.3.1.1. Indicates the function of Identifying the patient and matching the patient with his/her past history and medical records, FIG. 1.3.1.1.1. Indicates the process On the Initial Intake, FIG. 1.3.1.1.1.1. Indicates the Use of a Scanner to Verify 2 Forms of Identity Documentation and FIG. 1.3.1.1.1.2. Indicates the use of a Database to Match ID to Biometrics. FIG. 1.3.1.1.2. Indicates the method used on all visits including the first visit and every visit thereafter—Matching from at least 2 Biometric Sources. FIG. 1.3.1.1.2.1. Indicates the possibility to use Palm Vein Mapping, FIG. 1.3.1.1.2.2. Indicates the possibility to use Finger Capillary Mapping, FIG. 1.3.1.1.2.3. Indicates the possibility to use Fingerprint ID & FIG. 1.3.1.1.2.4. Indicates the possibility to use Facial Recognition Software—Connected to Video Inputs.

FIG. 1.3.1.2. Indicates the methods, systems and equipment of taking and storing the Vital Signs of the patient. FIG. 1.3.1.2.1. Indicates the Weight Sensors in Floor & Chair/Table, FIG. 1.3.1.2.2. Indicates the No Adjustment Blood Pressure Cuff to measure BP & Pulse, FIG. 1.3.1.2.3. Indicates the Bio-Electric Impedance Pads to test Bone Density, Body Fat %, BMI, Water Retention, Muscle Mass, Visceral Fat Levels, Resting Metabolism, Body Age, FIG. 1.3.1.2.4 Indicates the use of an Oximeter to measure O2 Saturation & Body Temperature, FIG. 1.3.1.2.5. Indicates the use of an Algorithm to Determine Height Based on Video Input & FIG. 1.3.1.2.6 Indicates that All Vital Signs are sent to the servers to be stored in the corresponding medical records, & when visiting with a medical professional, the most current vital signs are relayed to their attending medical professional.

FIG. 1.3.1.3. Indicates the systems and methods for automated Patient Intake. FIG. 1.3.1.3.1. Indicates the use of a Touchscreen Video Interface, FIG. 1.3.1.3.2. Indicates that are Asked Audibly & Through the GUI to Quickly Determine the Purpose of the Visit & FIG. 1.3.1.3.3. Indicates the use of Diagnosis Assistance Software Accessed From Servers to Diagnose or to Assist in Diagnosis & to Route the Patient to the Best Medical Professional for the Client's Needs FIG. 1.3.2. Indicates the methods, processes and systems to perform the patient Examinations, Consultations & Prescriptions of Treatment. FIG. 1.3.2.1. Indicates Examination. FIG. 1.3.2.1.1. Indicates that Depending on the Purpose for the Client's Visit, the Medical Professional can ask appropriate questions and review past medical records and test results, use Networked Digital Ophthalmoscopes, Otoscopes, Stethoscopic Array &/or High Resolution Cameras to Remotely See or Hear What They Need to Know, & FIG. 1.3.2.1.2. Indicates that Medical Professionals Can Also Ask the Patient to Perform Various Functions; i.e. Bend Certain Joints, Etc.

FIG. 1.3.1.4. Indicates the method of collecting payments. FIG. 1.3.1.4.1. Indicates that all patient payments are handled on location at the time of service via cash or electronic means & FIG. 1.3.1.4.2 indicates that all insurance billing is handled automatically by the Virtual Systems as indicated in FIG. 1.2.8.

FIG. 1.3.2.2. Indicates the Consultation Functions of the Medical Professionals and the intelligent software. FIG. 1.3.2.2.1 indicates the use of Diagnostic Software to Do a Diagnosis or Preliminary Diagnosis Inasmuch as the Software Permits, FIG. 1.3.2.2.2. Indicates that Medical Professionals Then Use Video Conferencing Interface, Medical History & Intake Data to Confirm the Preliminary Information Gathered By the Computer System & Perform a Consultation According to Standard Medical Practices & Tests Can Be Ordered, & FIG. 1.3.2.2.3. Indicates that If Additional Medical Professionals Are Needed, They Can Be Brought Into the Videoconference for the Consultation.

FIG. 1.3.2.3. Indicates the prescription of treatment and how the prescription is relayed to the client. FIG. 1.3.2.3.1 Indicates that Once the Medical Professional Diagnoses the Problems & Prescribes a Treatment, the Prescription is Sent Electronically to the Provider of Choice. If they don't have a Preferred Provider, One is Referred w/a Map Indicating How to Arrive at the Pharmacy or Therapy Provider's Location (When possible, these units will be placed in locations inside of or close to buildings with pharmacies) & FIG. 1.3.2.3.2 Indicates that the medical professional's notes and the prescription will be given to the client via electronic or printed means.

FIG. 1.3.3. Indicates the Robotics, Essential Physical Elements & Optional Medical Equipment. FIG. 1.3.3.1. Indicates the robotics section. FIG. 1.3.3.1.1. Indicates that Specific Robotic Components Can Be Changed & Substituted to Meet the Needs of Each Specific Configuration and can include any, all or none of the following robotic components, FIG. 1.3.3.1.2. Indicates that All Robots Controllable By Networked Medical Professionals or by Intelligent, Autonomous &/or Prespecified Programming. FIG. 1.3.3.1.3. Indicates that Sufficient Degrees of Freedom (DOF) are back-draftable to facilitate safe use in a human environment, FIG. 1.3.3.1.4. Indicates that System Can Use All, Any Combination or None of the Following Robotics, But Is Not Limited to These Robotic Tools Alone, FIG. 1.3.3.1.4.1. Indicates that 1 DOF Robotic Arc w/4+ DOF Robotic Arm & Attachment Tools, Instruments & Dexterous Robotic Hands w/Visual & Haptic Feedback, FIG. 1.3.3.1.4.2. Indicates the use of Mono or Tandem 7+ DOF Robotic Arm(s) & Attachment Tools, Instruments & Dexterous Robotic Hands w/Visual & Haptic Feedback

FIG. 1.3.3.2. Indicates the Essential Physical Elements. FIG. 1.3.3.2.1. Indicates the function of being able to Sit & Quickly take Vital Signs within 25-60 Seconds, FIG. 1.3.3.2.1.1. Indicates that All Sensors are Arranged so all vitals except BP can be measured simultaneously & the BP immediately thereafter, FIG. 1.3.3.2.2. Indicates an Array of Activateable Audio Sensors, Electric Potential Sensor, or low-power, high-frequency Doppler radar for Stethoscopic Functions, FIG. 1.3.3.2.3. Indicates that the Door Locks from Inside For Privacy, FIG. 1.3.3.2.4. Indicates the presence and use of Remote Screens to Cover Video Cameras to Provide Privacy if Client Changing is Needed, & FIG. 1.3.3.2.5. Indicates the use of a Chair & Table Combination that FIG. 1.3.3.2.5.1. In Models Used for X-Ray, Digital X-Ray Sensors are Embedded in the Table & the Walls Are Shielded from radiation.

FIG. 1.3.3.3. Indicates the option to integrate many other medical devices and modules that can be Handled By the Robots & Networked as indicated in FIG. 1.3.3.3.1. and can be integrated with Digital X-Ray Machines, Digital Ultrasound Machines, Digital EKG, EEG & ECG, Digital Vision Diagnostic & Treatment Machines, Remote &/or Autonomous Phlebotomist, an Automated Laboratory, Etc. FIGS. 1.3.3.3.1.1-7. and in FIG. 1.3.3.3.1.5.1. Medical Professionals Can Control the Robots to Collect Samples, in FIG. 1.3.3.3.1.5.2. Autonomous Phlebotomist uses stereoscopic vein mapping to create a three dimensional diagram of the veins, in FIG. 1.3.3.3.1.5.3. the computer algorithmically determines the optimal location, depth and angle for insertion of the needles, and in FIG. 1.3.3.3.1.5.4. the robots move in the preprogrammed pattern to insert the needle, draw the samples and withdraw the needle. Once samples are taken, preprogrammed robots (in an area separate from the Patient Area) perform standard lab procedures such as cultures, centrifuging, dehydrating, capturing images under a microscope for evaluation by remote medical professionals & other necessary processes performed in a typical medical laboratory as indicated in FIG. 1.3.3.3.1.6.1.

1. A facility, set of systems and methods that enables standard medical office functions to be performed in an unsupervised, remote kiosk or facility by automated systems and/or through the care of teleconferenced live and/or time-shifted medical professionals &/or autonomous computer and mechanical &/or robotic systems, comprising of
A) networked and remotely communicated and monitored &/or controlled sensors,
B) medical & non-medical equipment,
C) mechanical devices to position the patient and sensors respective to the patient (including the use or non-use of autonomous &/or remotely controlled robotics),
D) visual devices,
E) medical and non-medical imaging devices,
F) touch responding graphical user interfaces,
G) feedback & haptic feedback systems,
H) teleconferencing equipment,
I) printing equipment,
J) encrypted electronic audio, video & data communications systems,
K) electronic record keeping systems,
L) autonomous diagnostic software,
M) scanners,
N) biometric ID systems,
O) reporting systems &
P) referencing systems.

2. The facility, systems & methods of claim 1 that enables medical services to be remotely performed by remote medical professionals &/or autonomously performed, in either instance, without the presence of staff or other medical professionals at the point of service.

3. The facility, systems & methods of claim 1 include functions & services of
A) remote &/or automated patient identification & intake,
B) vitals (vital signs such as blood pressure, temperature, height, weight, O2 saturation, bone density, fluid saturation & retention, pulse, breathing sounds, sounds of the heart, sounds of the digestive track, visuals of the inner ear, various parts of the eye and body, etc.) measuring & recording,
C) symptom reporting,
D) live & delayed consultation by medical professionals,
E) various general & unlimited medical examination & testing, diagnostic, referral, prescribing, services,
F) treatment services,
G) billing, payment processing and record keeping services.

4. The facility, systems & methods of claim 1 enable the medical professionals' location(s) to be remote from the facility's location and can be consolidated in one location or distributed in many locations and the facility enables the client/patient to be served by automated systems inasmuch as possible and then multiple different medical professionals that might traditionally require them to meet in different locations from the one facility.

5. The facility, systems & methods of claim 1 enable that the facilities used by the client/patient are typically self-contained, but can also be built into an existing structure, facility or a mobile unit.

6. The facility, systems & methods of claim 1 enable the patient to be connected with the correct medical professional (whether the correct professional is a nurse practitioner, physician's assistant, general medical doctor or specialist) for their specific needs, thus minimizing over-utilization of overqualified & more costly medical professionals.

7. Systems that because of the flexibility of the robotic controls & facilities described in herein can also, but won't always, be outfitted to contain integrated sensors and robotics capable of providing x-ray, ECG, EEG, EKG, ultrasound, standard medical laboratory services and any other standard medical examinations or tests commonly in use.

8. The systems in claim 7 enables that as other networkable technologies are developed for medical testing and examinations, it is anticipated that they, too, will be able to be interfaced with the robotic systems in these facilities including additional services such as remote or autonomous phlebotomist may also be integrated with the system.

9. The systems in claim 7 enable the precise configuration and arrangement of the sensors and robotics to be adjusted to meet the specific needs of the clients typically served in the surrounding area of each facility.

10. The facilities described herein will provide biometric-based identity verification and be connected with networked data banks, servers and videoconferencing capabilities, thus increasing the value/scope of the usefulness beyond medical services and such usefulness will include civil services such as Federal, State, County, Municipality and other government & business interfaces wherein knowing with certainty the identity of one or more individuals and interfacing with a third party is needed to conduct interviews and/or transactions.

11. The facility, methods & systems in claim 1 make use of robotics, which are not patented, but are used as a tool in the invention to help deliver the services.

12. The facility, methods & systems in claim 1 network each of the components so that they are all accessible for data retrieval and controllable by the medical professionals and system administrators via the internet and records of such actions and data are stored in the system server.

13. The facility, methods & systems in claim 1 contains many components that are available from many suppliers and where this is the case, these components are not a part of the patent, but are components/parts/systems/tools/equipment that partially enable the delivery of the services promised by this invention.
